(19) United States
(12) Patent Application Publication
(10) Pub. No.: US 2013/0181377 A1
(43) Pub. Date: Jul. 18, 2013

(54) SEALING OR DAMPING PROFILED ELEMENT

(71) Applicants: Heiko Hoeft, Rosengarten OT Eckel (DE); Andreas Artus, Tabarz (DE)

(72) Inventors: Heiko Hoeft, Rosengarten OT Eckel (DE); Andreas Artus, Tabarz (DE)

(73) Assignee: DAETWYLER SEALING TECHNOLOGIES DEUTSCHLAND GMBH, Springe (DE)

(21) Appl. No.: 13/824,471

(22) PCT Filed: Oct. 7, 2011
(86) PCT No.: PCT/DE2011/050041

§ 371 Date: Apr. 4, 2013

(30) Foreign Application Priority Data
Oct. 8, 2010 (DE) 10 2010 047 772.9

(51) Int. Cl. F16J 15/02; F16F 1/37

(52) U.S. Cl. CPC F16J 15/022; F16F 1/37
USPC 264/299; 277/628; 267/153

(57) ABSTRACT

A sealing or damping profiled element for use in tunnel construction, construction at or below ground level, track superstructures and/or window façades and also a method for the production thereof. The sealing or damping profiled element (1) is made of a cross-linked elastomer and exhibits a fraction of at most two percent by weight of elastic microspheres (2). The sealing or damping profiled element (1) exhibits a lower specific weight and/or a lower maximum restoring force where there is strong compression.

The invention relates to a sealing or damping profiled element for use in tunnel construction, construction at or below ground level, track superstructures and/or window facades and to a method for the production thereof.

Sealing or damping profiled elements for use in tunnel construction, construction at or below ground level, track superstructures and/or window facades have been known in the art for some time. These sealing or damping profiled elements, particularly those for tunnel construction, construction at or below ground level and track superstructures, are routinely produced from a cross-linked elastomer, in order to withstand the comparatively high mechanical and other loads. A common disadvantage of these sealing or damping profiled elements known in the art is, however, the relatively high specific weight and/or the high maximum restoring forces which can arise when there is strong compression, e.g. in corner regions of joint seals, in which no cavities can be formed.

The problem addressed by the present invention is that of providing a sealing or damping profiled element for use in tunnel construction, construction at or below ground level, track superstructures and/or window facades which does not exhibit the disadvantages of the state of the art, particularly exhibits a lower specific weight where there is a substantially unchanged sealing function and/or a lower maximum restoring force where there is strong compression. A particular problem addressed by the present invention is that of providing a sealing or damping profiled element for use in tunnel construction, construction at or below ground level, track superstructures and/or window facades which permits a smaller maximum restoring force where the compression is the same or stronger compression where the maximum restoring force is the same compared with the state of the art.

The problem according to the invention is solved by the subject-matter of the independent claims.

In a first aspect, the invention provides a sealing or damping profiled element for use in tunnel construction, construction at or below ground level, track superstructures and/or window facades, wherein the sealing or damping profiled element consists of a cross-linked elastomer and exhibits a fraction of at most two percent by weight of elastic microspheres.

It has surprisingly emerged that a seal or damping profiled element, as is known in principle in the state of the art for use in tunnel construction, construction at or below ground level, track superstructures and/or window facades, can be significantly improved by mixing in elastic microspheres. The specific weight of the sealing or damping profiled element is reduced by the use of microspheres in this case, because part of the elastomer volume, e.g. 10-30%, can be replaced by the microsphere cavities. By using elastic microspheres, the mechanical properties of the sealing or damping profiled element, particularly the elasticity and sealing function, can be largely retained. It has been shown here that the restoring forces do not rise as quickly when there is strong compression of the sealing or damping profiled element according to the invention as in sealing or damping profiled elements according to the state of the art. This is particularly advantageous in the case of sealing or damping profiled elements or sections of a sealing or damping profiled element which may be exposed to strong compression, e.g. at the corners of tubbing seals. A theoretical volume utilization of >100% regularly occurs in this case. Through the use of elastic microspheres according to the invention, the maximum restoring forces can be significantly reduced, without the sealing effect, e.g. in the case of larger gaps and/or offsets, deteriorating. In the case of the sealing or damping profiled element according to the invention, greater compression can be achieved with a constant or even reduced maximum restoring force. The reduced maximum restoring forces mean that sealing or damping profiled elements according to the invention can be additionally used in areas of application in which this had not previously been possible. For example, the compression in the tunnel construction or construction at or below ground level category of a customary 20-50% with constant maximum restoring forces can be increased to 20-60 or even to 65%, as a result of which the operational range of such seals is significantly broadened.

Moreover, in the case of the sealing or damping profiled element according to the invention, the spring properties of the elastic microspheres can be combined with those of the elastomer. In the case of sealing or damping profiled elements, such as those used in track superstructures, e.g. rail supports, track bed mats, foot profiles and the like, the spring properties have hitherto been achieved by cavities in the extrusion direction. By using microspheres, for example microspheres with a diameter of 80-120 μm, the cavities can be better designed in structural terms. Such cavities can also be dispensed with completely, so that the spring properties thereof are taken over by the microspheres.

Sealing or damping profiled elements according to the invention may also be advantageously used in window and door facades. Profiled elements made of solid elastomer and/or foam rubber have hitherto been used. However, solid elastomer exhibits a comparatively low resistance to thermal conductivity and foam rubber can only be used for insulating and sealing functions, due to its low mechanical strength, but not for structural purposes. In this case, the invention enables elastomer profiled sections with significantly improved heat insulation, but substantially constant mechanical stability, to be provided.

A “cross-linked elastomer” is understood to refer to elastomers whose molecular chains are linked covalently to one another, as opposed to thermoplastic elastomers. “Elastomers” are all materials which exhibit rubber-elastic properties, in other words plastics which are dimensionally stable but elastically deformable, the glass transition point of which lies below room temperature. Examples of cross-linked elastomers are styrene-butadiene rubber (SBR), nitrile butadiene rubber (NBR) and ethylene propylene rubber (EPM, EPDM).

The term “elastic microspheres” refers to small, spherically formed, elastically deformable plastic particles, which exhibit a polymer enveloping layer delimiting a cavity. The cavity may contain a gas propellant, e.g. isopentane, isooctane or isobutene. The term is particularly understood to refer to expandable microspheres in this case, i.e. microspheres which increase greatly in volume under the effects of heat (e.g. at 80-190° C.), for example. In the expanded state, microspheres exhibit diameters in the micrometre range, e.g. 10-150 μm. Elastic microspheres are compressible and substantially resume their original form when the pressure eases.

A “sealing or damping profiled element” is in this case understood to mean an elastomer profiled element with a sealing or damping function, for example tubbing seals, concrete pipe seals, shaft seals, wedge seals, integrated seals, roll rings, rail supports, such as grooved rail supports, glass bed mats, guide rail sealing profiled sections, foot profiled sections, glazing profiled sections for windows and doors, sealing profiles for windows and doors, façade sealing profiled sections, noise protection seals and the like.

In a preferred embodiment, the sealing or damping profiled section exhibits a hardness which substantially corresponds to that of a microsphere-free sealing or damping profiled section provided for the same intended application, as has been used hitherto in the state of the art. This may require the Shore hardness of the cross-linked elastomer to be increased, in order to compensate for a loss of hardness caused by the microsphere fraction.

The proportion of microspheres is preferably 0.25 to 2% by wt., further preferably 0.25 to 1.5% by wt., further preferably 0.25 to 1.0% by wt. and particularly preferably 0.25 to 0.75% by wt., 0.25 to 0.5% by wt., 0.25 to 0.4% by wt. or 0.25 to 0.3% by wt. This is the weight component of unexpanded microspheres of the total weight of the starting mixture of cross-linked elastomer and unexpanded microspheres. It has emerged that the aforementioned quantity ranges produce an advantageous reduction in specific density or the maximum restoring force, without having a detrimental effect on the other mechanical properties of the sealing or damping profiled element according to the invention. For tubbing seals or tubbing sealing frames and for window façade seals, a range of 0.25 to 1.0% by wt., for seals in construction at or below ground level such as concrete pipe seals, wedge seals, integrated seals, roll rings, etc., a range of 0.25 to 0.5% by wt., and for rail supports, track bed mats, foot profiles, etc., a range of 0.25 to 2.0 % by wt., has proved particularly suitable, for example.

In a further preferred embodiment of the present invention, the microspheres exhibit a diameter of 40-120 μm, preferably of 40-80 μm or 80-120 μm, in the expanded state. The figures relate to mean values in this case. A batch of microspheres with a diameter of 60 μm, for example, exhibits a corresponding size distribution, wherein the diameter is approximately 60 μm, as a mean value. Microspheres with a diameter range of 40 to 80 μm in the expanded state are ideally suited to profiled elements, for example, which are used in tunnel construction, e.g. as tubbing seals, or also in construction at or below ground level, e.g. as concrete pipe seals. By using microspheres with a diameter of 80 to 120 μm in the expanded state, elastomer profiled sections for track superstructures, e.g. track bed mats and the like, can be produced with advantageous spring properties. Combinations of these diameter ranges are also possible, of course. Microspheres with a particular mean diameter, e.g. 40, 60, 80 or 120 μm are preferably used for a profiled section. Mixtures of microspheres of different diameters may also be used, however.

The microspheres are preferably evenly distributed over the cross-section of the sealing or damping profiled element. Uneven distributions are also possible, however, e.g. in the form of a gradient, of clusters and the like.

The microspheres may exhibit an acrylonitrile casing, for example, and contain a gas propellant such as isobutene, isopentane or isooctane, for example. Microspheres of this type exhibit good spring properties, which are not lost even over a prolonged period and with prolonged compression. The thickness of the acrylonitrile casing can vary and be adapted to the purpose accordingly, wherein the thickness of the casing preferably increases with the diameter.

The sealing or damping profiled element according to the invention may be configured with or without the cavities in the extrusion direction known in the state of the art. In a preferred embodiment, however, cavities of this kind are dispensed with, so that the function thereof is assumed by the microspheres.

The cross-linked elastomer used for the sealing and damping profiled element according to the invention is preferably EPM, EPDM, NBR or SBR. However, other cross-linked elastomers known to the person skilled in the art can also be advantageously used.

In a further aspect, the invention also relates to a method of producing a sealing or damping profiled section according to the invention, wherein the method comprises the following steps: a) mixing of the cross-linked elastomer with the unexpanded elastic microspheres and b) extruding the mixture from the cross-linked elastomer and the unexpanded elastic microspheres. In a preferred embodiment of the method according to the invention, a further step then follows, namely c) vulcanizing the extruded mixture from the cross-linked elastomer and the unexpanded elastic microspheres.

The microspheres in this case are added to the cross-linked elastomer in the unexpanded state in a proportion of maximum 2% by wt., preferably 0.25-2% by wt., further preferably 0.25-1.5% by wt., further preferably 0.25-1.0% by wt., further preferably 0.25-0.75% by wt. and particularly preferably 0.25-0.5% by wt., 0.25-0.4% by wt. or 0.25-0.3% by wt., relative to the weight of the mixture of the microspheres and the raw mixture, comprising the elastomer and possibly further additives. During mixing, the temperature level is kept below the expansion temperature of the microspheres, which may be 80 to 120° C., for example. Extrusion then takes place above the expansion temperature for the microspheres, e.g. at >120° C., wherein the microspheres expand greatly under the effects of the heat and achieve their target volume. The profiled element can then be vulcanized.

The invention is explained in greater detail below by way of examples using the figures.

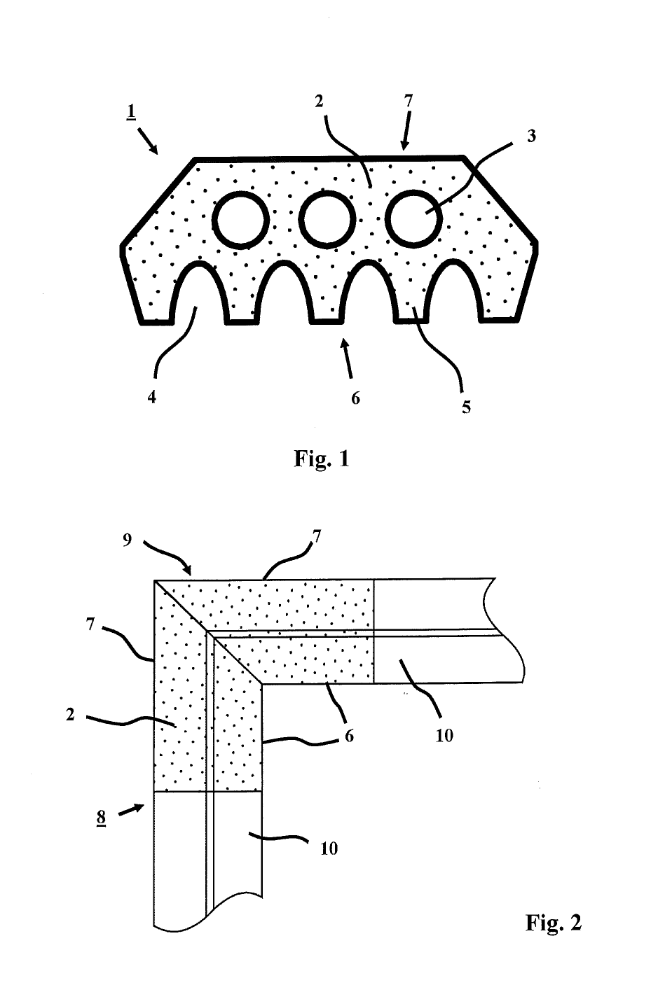

FIG. 1 Cross-section through a tubbing seal.

FIG. 2 Lateral top view of the corner region of a tubbing seal frame.

A cross-section through a billet-shaped tubbing seal 1 is shown in FIG. 1. A tubbing seal 1 of this kind is inserted with the seal base 6 into a matching groove in a tubbing. The opposite side 7 of the tubbing seal 1 is adjacent to the matching side 7 of another tubbing seal 1 of the adjacent tubbing in each case during use. The seal base 6 exhibits flutes 4, whereby sealing ribs 5 are formed. Moreover, channel-like cavities 3 are provided in the sealing body running in a longitudinal direction, i.e. in the extrusion direction. In the case of the tubbing seal 1 illustrated, microspheres 2 depicted as dots are evenly distributed over the cross-section. The tubbing seal 1 exhibits a closed surface in this case.

In FIG. 2, a corner region of the tubbing seal frame 8 is depicted as a lateral top view. The seal base 6 to be inserted in the tubbing groove is to the right or below in this case; the opposite side 7 forming the future contact surface with another tubbing seal to the left or above. The region of a frame corner 9 of the tubbing seal frame 8 is depicted. Frame corners 9 of this kind are routinely connected to sealing billets 10 subsequently and do not exhibit any cavities 3. In the case of the tubbing seal frame 8 illustrated here, the frame corners 9 are provided with microspheres 2, which mean that the frame corner 9 can be compressed more strongly without the restoring forces increasing sharply and possibly causing damage to the groove or the adjacent tubbing body. In the embodiment represented here, the sealing billets 10 are not provided with microspheres.

### EXEMPLARY EMBODIMENT

0.3% by wt. relative to the final mixture of the raw mixture and microspheres, gas propellant-filled microspheres with an acrylonitrile casing with a mean diameter of 40 μm were added to an EPDM raw mixture. The raw mixture was extruded and then vulcanized, in order to produce a tubbing seal. A microscopic analysis revealed a uniform distribution of microspheres over the sealing cross-section. The outer surfaces of the seal were closed. A material and weight saving of approximately 30% was achieved compared with a comparative seal without microspheres. The seal demonstrated lower maximum restoring forces at high compression than a comparable seal without microspheres. The sealing function was not detrimentally affected.

1. A sealing or damping profiled element for use in tunnel construction, construction at or below ground level, track superstructures and/or window façades, wherein the sealing or damping profiled element (1) is comprised of a cross-linked elastomer and elastic microspheres (2), wherein said elastic microspheres (2) are present in an amount of at most two percent by weight.

2. The sealing or damping profiled element according to claim 1, wherein the sealing or damping profiled section (1) exhibits a hardness which is substantially the same compared with a microsphere-free sealing or damping profiled section provided for the same intended application.

3. The sealing or damping profiled element according to claim 1, wherein the proportion of elastic microspheres (2) is 0.25 to 2% by wt. based on the weight of elastomer and elastic microspheres.

4. The sealing or damping profiled element according to claim 1, wherein the microspheres (2) exhibit an average diameter of 40-120 μm.

5. The sealing or damping profiled element according to claim 1, wherein the microspheres (2) are evenly distributed over the cross-section of the sealing or damping profiled element (1).

6. The sealing or damping profiled element according to claim 1, wherein the microspheres (2) are gas propellant-filled microspheres with an acrylonitrile casing.

7. The sealing or damping profiled element according to claim 1, wherein the sealing or damping profiled element (1) exhibits no cavities (2) in the extrusion direction.

8. The sealing or damping profiled element according to claim 1, wherein the cross-linked elastomer is EPM, EPDM, NBR or SBR.

9. A method of producing a sealing or damping profiled element, comprising the steps
a) mixing a cross-linked elastomer with unexpanded elastic microspheres and
b) extruding the mixture of cross-linked elastomer and unexpanded elastic microspheres into a mold to form the sealing or damping profiled element.

10. The method according to claim 9, further comprising the step c) vulcanizing the extruded mixture of cross-linked elastomer and the unexpanded elastic microspheres.

11. The sealing or damping profiled element according to claim 1, wherein the proportion of elastic microspheres (2) is 0.25 to 1.5% by wt.

12. The sealing or damping profiled element according to claim 1, wherein the proportion of elastic microspheres (2) is 0.25 to 1.0% by wt.

13. The sealing or damping profiled element according to claim 1, wherein the proportion of elastic microspheres (2) is 0.25 to 0.75% by wt.

14. The sealing or damping profiled element according to claim 1, wherein the proportion of elastic microspheres (2) is 0.25 to 0.5% by wt.

15. The sealing or damping profiled element according to claim 1, wherein the proportion of elastic microspheres (2) is 0.25 to 0.4% by wt.

16. The sealing or damping profiled element according to claim 1, wherein the proportion of elastic microspheres (2) is 0.25 to 0.3% by wt.

17. The sealing or damping profiled element according to claim 1, wherein the microspheres (2) exhibit an average diameter of 40-80 μm.

18. The sealing or damping profiled element according to claim 1, wherein the microspheres (2) exhibit an average diameter of 80-120 μm.

19. A sealing or damping profiled element for use in tunnel construction, construction at or below ground level, track superstructures and/or window façades, wherein the sealing or damping profiled element (1) consists essentially of a cross-linked elastomer and elastic microspheres (2), wherein said elastic microspheres (2) are present in an amount of at most two percent by weight.

20. The method according to claim 9, wherein the proportion of elastic microspheres (2) is 0.25 to 2% by wt. based on the weight of elastomer and elastic microspheres.
